(19) United States
(12) Patent Application Publication
(10) Pub. No.: US 2006/0038493 A1
(43) Pub. Date: Feb. 23, 2006

(54) Plasma display panel

(76) Inventor: Ki-Dong Kim, Suwon-si (KR)

Correspondence Address: MCGUIREWOODS, LLP, 1750 TYSONS BLVD, SUITE 1800, MCLEAN, VA, 22102, US

(21) Appl. No.: 11/206,123

(22) Filed: Aug. 18, 2005

(30) Foreign Application Priority Data
Aug. 20, 2004 (KR) 10-2004-0065886

(51) Int. Cl. H01J 17/49

(52) U.S. Cl. 313/587; 313/586; 313/582

(57) ABSTRACT

A plasma display panel including an upper substrate, a lower substrate facing the upper substrate, a plurality of discharge cells between the upper substrate and the lower substrate, and a magnesium oxide layer arranged to correspond to the discharge cells. A composition of oxygen exceeds a composition of magnesium in the magnesium oxide layer.

### CROSS REFERENCE TO RELATED APPLICATION

This application claims priority to and the benefit of Korean Patent Application No. 10-2004-0065886, filed on Aug. 20, 2004, which is hereby incorporated by reference for all purposes as if fully set forth herein.

### BACKGROUND OF THE INVENTION

1. Field of the Invention

The present invention relates to a plasma display panel, and more particularly, to a plasma display panel having a structure that may be more sputter resistant.

2. Discussion of the Background

Generally, a plasma display panel (PDP) displays images through gas discharge. A discharge gas is filled between two substrates having a plurality of electrodes, and applying a discharge voltage to the discharge gas generates ultraviolet rays, which excite a phosphor layer formed in a predetermined pattern to display an image.

The PDP may be a direct current (DC) PDP or an alternating current (AC) PDP. In a DC PDP, electrodes are exposed in a discharge space, and electric charges move directly between corresponding electrodes. Conversely, in an AC PDP, a dielectric layer covers at least some of the discharge electrodes. Hence, a discharge is performed by moving wall charges accumulated on the dielectric layer.

Since the charges directly move between corresponding electrodes in the DC PDP, the electrodes may be damaged. Thus, an AC PDP having a three-electrode surface discharge structure is often used.

A general AC PDP includes an upper substrate, on which an image is displayed, and a lower substrate arranged substantially in parallel with the upper substrate. Sustain electrode pairs, including a common electrode and a scan electrode, are formed on a lower surface of the upper substrate, and an upper dielectric layer covers the sustain electrode pairs. Additionally, address electrodes are formed on an upper surface of the lower substrate in a direction crossing the sustain electrode pairs, and a lower dielectric layer covers the address electrodes. Barrier ribs are formed on the lower dielectric layer to define discharge cells. A discharge gas is filled in the discharge cells, and either a red, green, or blue phosphor layer is arranged in each discharge cell to display the corresponding color.

In such a PDP, a magnesium oxide (MgO) layer may cover the upper dielectric layer. The MgO layer protects the upper dielectric layer from damage due to ion sputtering during discharge, and it emits secondary electrons. When the MgO layer emits a large amount of secondary electrons, the discharge operation may be more easily performed, thereby allowing application of a lower sustain voltage between the common electrode and the scan electrode, which reduces power consumption.

The MgO layer may be deposited on the lower surface of the upper dielectric layer. However, if a density of the MgO layer is too low, the layer's ability to prevent damage from sputter decreases, which shortens the PDP's lifespan.

### SUMMARY OF THE INVENTION

The present invention provides a PDP that may be more sputter resistant by forming an MgO layer having a higher composition of oxygen than magnesium, thereby increasing the MgO layer's density.

Additional features of the invention will be set forth in the description which follows, and in part will be apparent from the description, or may be learned by practice of the invention.

The present invention discloses a plasma display panel including an upper substrate, a lower substrate facing the upper substrate, a plurality of discharge cells between the upper substrate and the lower substrate, and a magnesium oxide layer arranged to correspond to the discharge cells. A composition of oxygen exceeds a composition of magnesium in the MgO layer.

The present invention also discloses a plasma display panel including an upper substrate, a plurality of pairs of sustain electrodes arranged on a lower surface of the upper substrate, an upper dielectric layer substantially covering the pairs of sustain electrodes, a lower substrate facing the upper substrate, address electrodes arranged on an upper surface of the lower substrate and in a direction crossing the pairs of sustain electrodes, and a lower dielectric layer substantially covering the address electrodes. A barrier rib is arranged between the upper substrate and the lower substrate to define discharge cells, and each discharge cell includes a pair of sustain electrodes and an address electrode. A phosphor layer is arranged in the discharge cells, a discharge gas is in the discharge cells. A magnesium oxide layer is arranged on a lower surface of the upper dielectric layer, and a composition of oxygen exceeds a composition of magnesium in the magnesium oxide layer.

The present invention also discloses a protective layer for a display panel including a plurality of discharge cells including magnesium and oxygen. A composition of the oxygen exceeds a composition of the magnesium.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view showing a PDP according to an embodiment of the present invention.

FIG. 3 is a graph of refractive index according to a ratio between oxygen and magnesium.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It is understood that when an element or layer is referred to as being “on” or “connected to” or “connected with” another element or layer, it can be directly on or directly connected to or with the other element or layer or intervening elements or layers may be present.

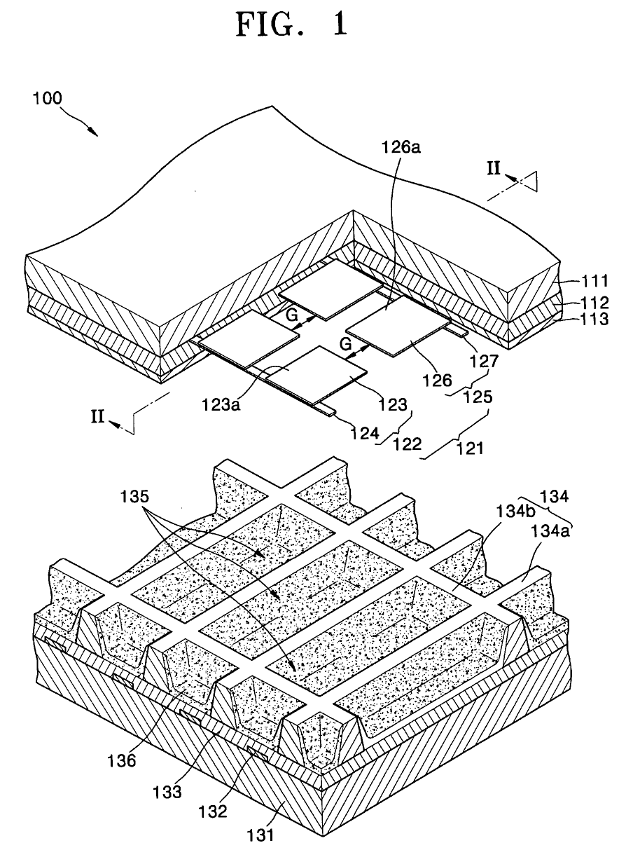

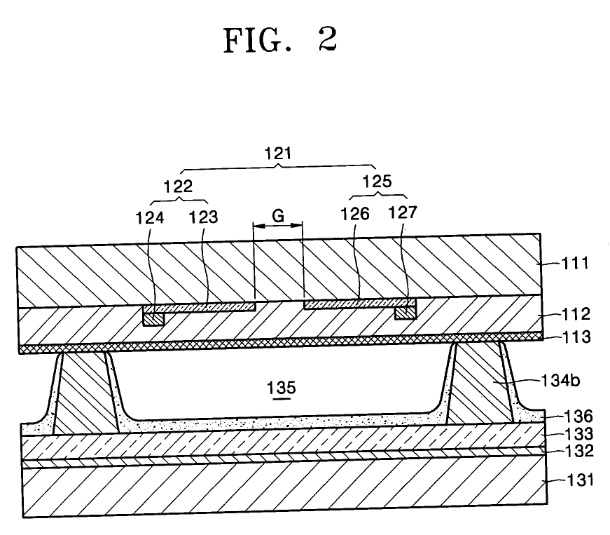

FIG. 1 is an exploded perspective view showing a plasma display panel (PDP) according to an embodiment of the present invention, and FIG. 2 is a cross-sectional view of the PDP along line II-II of FIG. 1.

Referring to FIG. 1 and FIG. 2, the PDP 100 may include an upper substrate 111 and a lower substrate 131 facing the upper substrate 111. A plurality of pairs of sustain electrodes 121 are arranged on a surface of the upper substrate 111 that faces the lower substrate 131, and an upper dielectric layer 112 substantially covers the pairs of sustain electrodes 121. An MgO protective layer 113, which is described below, substantially covers the upper dielectric layer 112.

Each pair of sustain electrodes 121 includes a common electrode 122 and a scan electrode 125 with a discharge gap G between them. The common electrode 122 includes a transparent electrode 123 and a bus electrode 124 coupled with the transparent electrode 123, and the scan electrode 125 includes a transparent electrode 126 and a bus electrode 127 coupled with the transparent electrode 126.

The transparent electrodes 123 and 126 may be formed of a transparent material, such as an indium tin oxide (ITO), so that they may transmit visible rays emitted from a phosphor layer 136. The bus electrodes 124 and 127 are coupled with the transparent electrodes 123 and 126, respectively, to apply voltages to the transparent electrodes 123 and 126. The bus electrodes 124 and 127 may be formed of a highly conductive metal in order to improve electric resistances of the transparent electrodes 123 and 126, which are formed of less conductive ITO.

The bus electrodes 124 and 127 are narrower than the transparent electrodes 123 and 126, and they are arranged substantially in parallel with transverse barrier ribs 134b. Additionally, the transparent electrode 123 includes a plurality of protruded electrodes 123a, which are separated from each other, have longitudinal barrier ribs 134a therebetween, and are coupled with the bus electrode 124. Further, the transparent electrode 126 includes a plurality of protruded electrodes 126a, which are separated from each other, have longitudinal barrier ribs 134a therebetween, and are coupled with the bus electrode 127. A protruded electrode 123a and a protruded electrode 126a are arranged at each discharge cell 135 with the discharge gap G between them. Accordingly, since portions of the transparent electrodes 123 and 126, which correspond to the longitudinal barrier ribs 134a, are removed, discharge areas of the transparent electrodes 123 and 126 may be reduced, thereby limiting electric currents flowing in the discharge areas and reducing power consumption.

Address electrodes 132 are arranged on a surface of the lower substrate 131 facing the upper substrate 111 and in a direction crossing the sustain electrode pairs 121. A lower dielectric layer 133 substantially covers the address electrodes 132, and a barrier rib 134 is formed on the lower dielectric layer 133.

The barrier rib 134 partitions the space between the upper and lower substrates 111 and 131 into plurality of discharge cells 135 to prevent cross talk between adjacent discharge cells 135. The barrier rib 134 includes longitudinal barrier ribs 134a, which are separated from each other with predetermined intervals or spaces therebetween, and transverse barrier ribs 134b, which extend from sides of the longitudinal barrier ribs 134a in a direction crossing the longitudinal barrier ribs 134a. Here, the longitudinal barrier ribs 134a are arranged in parallel with, and between, adjacent address electrodes 132. The longitudinal and transverse barrier ribs 134a and 134b form four sides of the discharge cells 135, which are partitioned in a matrix.

Phosphors are applied on sides of the barrier rib 134 and an upper surface of the lower dielectric layer 133 to form the phosphor layer 136. The phosphors emit red, green, or blue light to display a color image, thus red, green, and blue phosphor layers are formed according to the phosphor's emitted color.

Additionally, the discharge cells 135 may be divided into red, green, and blue discharge cells according to the emitted color of phosphor layer 136, and a unit pixel includes three adjacent red, green, and blue discharge cells. A discharge gas may be filled in the discharge cells 135. The upper substrate 111 and the lower substrate 131 may be coupled and sealed together by a sealing material (not shown) formed on edges of the upper and lower substrates 111 and 131.

Operations of the PDP 100 are as follows. Applying an address voltage between a scan electrode 125 and an address electrode 132 of a corresponding discharge cell 135 generates an address discharge, thereby selecting the corresponding discharge cell 135. Next, a sustain voltage is alternately applied between the common electrode 122 and the scan electrode 125 of the selected discharge cell 135, thereby generating a sustain discharge between the common and scan electrodes 122 and 125, which excites the discharge gas within the discharge cell. Then, ultraviolet rays are emitted as the energy level of the discharge gas decreases. The ultraviolet rays excite the phosphor layer 136 formed in the discharge cell 135, and the phosphor layer 136 emits visible rays to display an image.

Additionally, an MgO protective layer 113 may be formed to substantially cover the upper dielectric layer 112. The MgO protective layer 113 may prevent the upper dielectric layer 112 from being damaged due to ion sputtering and it emits secondary electrons. When a sufficiently large amount of secondary electrons are emitted, the sustain discharge may be more easily performed. Thus, the sustain voltage applied between the common electrode 122 and the scan electrode 125 may be lowered, thereby reducing power consumption.

The MgO layer 113 may be formed in various ways, including, for example, a physical vapor deposition method. The physical vapor deposition method may be an evaporation method or a sputtering method. The evaporation method uses heat to vaporize the material to be deposited, and the sputtering method vaporizes the material to be deposited using kinetic energy of a plasma forming gas. In the evaporation method, resistance heating, electron beam, and arc may be used as an evaporation source. An ion plating method combines the evaporation and sputtering methods. The ion plating method uses the evaporation source of the evaporation method while adopting the plasma used in the sputtering method, and ionizes evaporation atoms, and reaction gas if necessary, to increase kinetic energy and reactivity. Accordingly, the ion plating method may provide a fast deposition speed through evaporation and a dense thin film structure and compound forming ability through sputtering.

According to the physical vapor deposition method, MgO particles that are sublimated and scattered by sufficiently high temperature heat are cooled down and crystallized on the lower surface of the upper dielectric layer 112, and the MgO crystals grow to form the MgO layer 113. The MgO layer 113 deposited on the lower surface of the upper dielectric layer 112 through the above processes may have a predetermined density, and as the density of the MgO layer 113 increases, the sputter-resistance may be improved and a lifespan of the PDP 100 may increase.

The density of the MgO layer 113 is affected by a ratio of the composition of oxygen to the composition of magnesium in the layer, that is, a value of O/Mg. The ratio of the composition of oxygen to the composition of magnesium in the MgO layer is a ratio of the number of oxygen to the number of magnesium in a unit volume. According to embodiments of the present invention, the composition of oxygen is larger than the composition of magnesium. For example, the value of O/Mg is set to be larger than 1 in order to increase the density of the MgO layer 113.

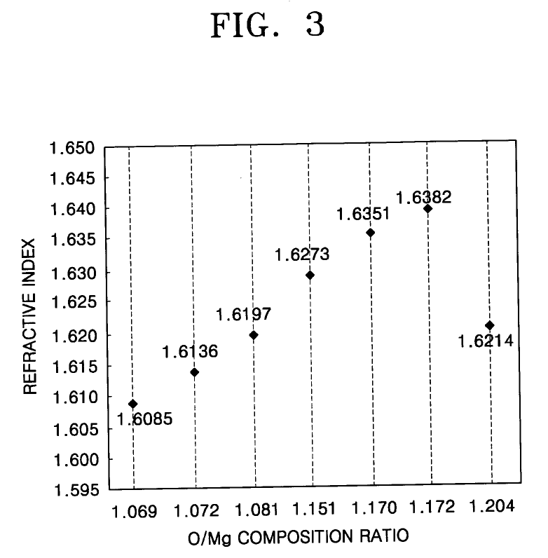

The value of O/Mg may be set within an optimal range in order to obtain a density that provides sufficient sputter-resistance. The optimal range of oxygen and magnesium in the MgO layer 113 may be set by referring to the experimental data shown in FIG. 3.

FIG. 3 is a graph of a refractive index of an MgO layer according to an O/Mg composition ratio. Here, the refractive index represents the density of the MgO layer, and the O/Mg composition ratio of the MgO layer is the relative value assuming the O/Mg composition ratio to be 1 in a single crystal of MgO.

Referring to FIG. 3, when the composition of oxygen exceeds the composition of magnesium, that is, as the value of the O/Mg composition ratio increases, the refractive index of the layer gradually increases, and when the value of O/Mg is about 1.172, the refractive index is about 1.6382, that is, the maximum. Then, as the value of O/Mg further increases, the refractive index gradually decreases.

The increase in refractive index means that the density of the MgO layer 113 increases. Thus, when the value of O/Mg is about 1.172, the density of MgO layer 113 is at the maximum value. Therefore, a range for the O/Mg composition ratio may be set to values that are greater and less than the value of O/Mg where the density of the MgO layer 113 is at its maximum.

In the present embodiment, the ratio of the composition of oxygen to the composition of magnesium may be in a range of about 1.100 to about 1.200, and more desirably, in the range of about 1.150 to about 1.170. In this latter case, the refractive index is about 1.6200 or greater, which may provide a sufficiently dense MgO layer 113.

As described above, according to embodiments of the present invention, the composition of oxygen exceeds the composition of magnesium in the MgO layer so that the MgO layer may have sufficient density, thereby improving the sputter-resistance of the MgO layer and increasing the PDP's lifespan.

Embodiments of the present invention have been shown and described by referring to the three electrode surface discharge PDP as an exemplary structure of a PDP. However, embodiments of the present invention may be applied to any PDP structure or to any display panel where an MgO protective layer may be utilized.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
an upper substrate;
a lower substrate facing the upper substrate;
a plurality of discharge cells between the upper substrate and the lower substrate; and
a magnesium oxide (MgO) layer arranged to correspond to the discharge cells,
wherein a composition of oxygen exceeds a composition of magnesium in the MgO layer.

2. The PDP of claim 1, wherein a ratio of the composition of oxygen to the composition of magnesium in the MgO layer is in a range of about 1.100 to about 1.200.

3. The PDP of claim 2, wherein a ratio of the composition of oxygen to the composition of magnesium in the MgO layer is in a range of about 1.150 to about 1.170.

4. The PDP of claim 1, wherein the MgO layer is formed using a physical vapor deposition method.

5. The PDP of claim 4, wherein the physical vapor deposition method comprises an ion plating method.

6. A plasma display panel (PDP), comprising:
an upper substrate;
a plurality of pairs of sustain electrodes arranged on a lower surface of the upper substrate;
an upper dielectric layer substantially covering the pairs of sustain electrodes;
a lower substrate facing the upper substrate;
address electrodes arranged on an upper surface of the lower substrate and in a direction crossing the pairs of sustain electrodes;
a lower dielectric layer substantially covering the address electrodes;
a barrier rib arranged between the upper substrate and the lower substrate, and defining discharge cells, each discharge cell comprising a pair of sustain electrodes and an address electrode;
a phosphor layer arranged in the discharge cells;
a discharge gas in the discharge cells; and
a magnesium oxide (MgO) layer arranged on a lower surface of the upper dielectric layer,
wherein a composition of oxygen exceeds a composition of magnesium in the MgO layer.

7. The PDP of claim 6, wherein a ratio of the composition of oxygen to the composition of magnesium in the MgO layer is in a range of about 1.100 to about 1.200.

8. The PDP of claim 7, wherein a ratio of the composition of oxygen to the composition of magnesium is in a range of about 1.150 to about 1.170.

9. The PDP of claim 6, wherein the MgO layer is formed using a physical vapor deposition method.

10. The PDP of claim 9, wherein the physical vapor deposition method comprises an ion plating method.

11. A protective layer for a display panel including a plurality of discharge cells, comprising:
magnesium; and
oxygen,
wherein a composition of the oxygen exceeds a composition of the magnesium.

12. The protective layer of claim 11, wherein a ratio of the composition of oxygen to the composition of magnesium is in a range of about 1.100 to about 1.200.

13. The protective layer of claim 12, wherein a ratio of the composition of oxygen to the composition of magnesium is in a range of about 1.150 to about 1.170.

14. The protective layer of claim 12, wherein the protective layer is formed using a physical vapor deposition method.

15. The protective layer of claim 14, wherein the physical vapor deposition method comprises an ion plating method.

16. A plasma display panel (PDP), comprising:
the protective layer of claim 11,
wherein the protective layer is arranged within the discharge cells.

17. The PDP of claim 16, further comprising:
a dielectric layer substantially covering discharge electrodes that generate a sustain discharge that causes light to be emitted from the PDP,
wherein the protective layer is arranged on at least a portion of the dielectric layer covering the discharge electrodes.
